(19) United States
(12) Patent Application Publication
(10) Pub. No.: US 2009/0103409 A1
(43) Pub. Date: Apr. 23, 2009

(54) COMPENSATING GAIN OF AN OPTICAL RECORDING APPARATUS

(75) Inventor: Johannes Leopoldus Bakx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/577,735

(22) PCT Filed: Oct. 20, 2005
(86) PCT No.: PCT/IB05/53440

§ 371 Date: Apr. 23, 2007

(30) Foreign Application Priority Data
Oct. 26, 2004 (EP) 04105291.1

(51) Int. Cl. G11B 7/00

(52) U.S. Cl. 369/53.35; 369/106; G9B/7

(57) ABSTRACT

The present invention relates to an optical recording apparatus capable of recording information on an optical record carrier. Radial tracking control is performed by the 3 spot differential push pull (PP) method. The optical recording apparatus has means for obtaining a first and second difference signal from detection signals of a reflection of a main light beam (C) and a first and a second sub light beam (A,B), and means for subtracting the second difference signal from the first difference signal so as to obtain a tracking error signal (TES). The second difference signal is adjusted by a gain factor (g) so as to compensate for a difference in intensity between the reflected light of the first and the second sub light beams during information writing. In particular, a solution may compensate for the difference in the reflections for the first and second sub light beam (A,B) so that a possible radial offset is avoided.

The present invention relates to an optical recording apparatus capable of recording information on an optical record carrier, wherein the optical recording apparatus performs radial tracking control by the three spot differential push-pull tracking method.

In an optical reproducing and/or recording apparatus for the light beam to trace accurately a track where pits or marks representing information are arranged in a row, a fast and precise control mechanism is indispensable. The optical reproducing and/or recording apparatus controls the position of the convergence of the light spot for reading the information, so that the light spot keeps tracing the track. The position control of the light spot is effected in two dimensions. The control in the direction of the optical axis is effected by focus control means, while control in the radial direction of the record carrier is effected by tracking control means. These controls are effected by feedback control in which the position of the light spot is controlled so as to eliminate the occurrence of an error, the error being defined as the difference between the target position of the light spot and the current position. Thus, for recording information a radial offset may be defined as the difference between the center of the written marks or pits and the center of the so-called pregroove that guides where the written marks ideally are to be written.

Several methods are available for obtaining the error in a radial direction, one such method being the push-pull (PP) method where a tracking error signal is generated on the basis of the level difference between optical signals detected in an optical sensor of the optical reproducing apparatus. Another option is the differential time (or phase) detection (DTD) method, a phase difference between the optical signals detected in the optical sensors of the optical reproducing apparatus is applied for generating a radial tracking error signal. The DTD method was originally introduced by Braat as disclosed in U.S. Pat. No. 4,057,833.

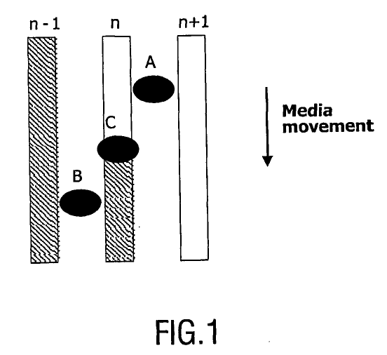

State-of-the-art differential PP methods apply the 3-spot method where a main light beam follows the track of information and two auxiliary light beams are shifted in opposite directions relative to the track. In FIG. 1, this is schematically illustrated for a recording situation of a DVD media, where the main light beam is marked C and the two auxiliary light beams are marked A and B, respectively. The track n−1 is already recorded; the track n is in the process of being recording by the main light beam C, while the track n+1 is not yet recorded. Various problems arise from applying the 3-spot method for a recording situation such as power broadening of the laser beam during writing.

Hence, an improved recording apparatus would be advantageous, and in particular a more precise and/or reliable optical recording apparatus would be advantageous.

However, an hitherto unrecognized problem is that the differences between the local optical environment of the three spots A, B and C lead to an offset in the expression for the radial error signal, i.e. there is an asymmetry in the surroundings of the two auxiliary light beams A and B, and an irregularity in the reflections results. In particular, analytic expressions to analyze these differences have never been disclosed before, nor have the solutions to these expressions been exploited to compensate for the resulting offset in the radial error signal.

Accordingly, the invention preferably seeks to mitigate, alleviate or eliminate one or more of the above-mentioned disadvantages singly or in any combination. This object and several other objects are obtained in a first aspect of the invention by providing an optical recording apparatus capable of recording information on an optical record carrier, said optical recording apparatus performing tracking control by generating a tracking error signal based on detection signals of reflected light of a main light beam and a first and a second sub light beams, the main light beam being focused into a spot focused on a track of an optical record carrier, the first and a second sub light beams being focused into spots that are offset in opposite directions in a perpendicular direction relative to the track of the optical record carrier, the optical recording apparatus comprising:

means for obtaining a first difference signal from detection signals of a reflection of the main light beam, said detection signals being averaged using an appropriate time constant,

means for obtaining a second difference signal from detection signals of a reflection of the first and second sub light beam, and

means for subtracting the second difference signal from the first difference signal so as to obtain a tracking error signal, said second difference signal being adjusted by a gain factor (g) so as to compensate at least partly for a difference in intensity between the reflected light of the first and second sub light beams during information writing.

The invention is particularly, but not exclusively, advantageous for obtaining an improved optical recording apparatus. In particular, the apparatus according to the present invention provides a more precise and thus more reliable optical recording apparatus.

The optical record carrier can be in the form of an optical record carrier, such as a recordable or rewritable CD, DVD or Blu-Ray record carrier. Alternatively, the optical record carrier can be in the form of a rectangular card. Also other forms of the optical record carrier are possible.

In the first aspect of the invention, the invention relates to a situation, wherein the first difference signal is averaged using an appropriate time constant. Thus, an averaging procedure is performed, possibly by application of a low-pass filtering circuit.

The second tracking error signal may be adjusted by the gain factor (g) so as to at least partly eliminate a radial offset of the main light beam during information writing. For recording information a radial offset may be defined as the difference between the center of the written marks and center of the so-called pregroove that guides where the written marks ideally are to be written. Thus, the precision of the apparatus is enhanced.

In particular, the gain factor (g) may be substantially equal to a correction factor (G) of the track of the optical record carrier divided by the sum of the intensity ratios (r_{A}, r_{B}) of the first and the second sub light beams relative to the main light beam as the analysis to be found below demonstrates that this value of the gain factor is beneficial. The correction factor (G) is known from the standard expression for the three spot push-pull radial error tracking method for the reading case.

The first sub light beam may be behind the main light beam relative to a rotational direction of the optical record carrier, and the second sub light beam may be ahead of the main light beam relative to a rotational direction of the optical record carrier, and wherein the reflected light from the first sub light beam may have a larger intensity than the reflected light from the second sub light beam and/or the main light beam during information writing as it is the case for DVD+-R/RW media.

The first sub light beam may be ahead of the main light beam relative to a rotational direction of the optical record carrier, and the second sub light beam may be behind the main light beam relative to a rotational direction of the optical record carrier, and wherein the reflected light from the first sub light beam may have a larger intensity than the reflected light from the second sub light beam and/or the main light beam during information writing as it is the case for the CD-R/RW media.

In particular, the gain factor (g) may be substantially equal to ⅓ times a correction factor (G) of the track of the optical record carrier as beneficial for DVD recording media. Alternatively, the gain factor (g) may be substantially equal to 1/2.7 times a correction factor (G) of the track of the optical record carrier for the CD recording media, when being recorded according to the first aspect of the invention.

The value of the gain factor (g) may be determined by calibration, either during the manufacturing of the optical recording apparatus, or as part of a calibration procedure before recording information on one or more optical record carriers. Information on the gain factor (g) may also be read from an area on the optical record carrier, said area containing information about a recording process whereby information can be recorded on the optical record carrier. Thus, the information may be easily obtained by the user or provided by the manufacturer.

In a second aspect, the invention relates to an optical recording apparatus capable of recording information on an optical record carrier, and capable of reproducing information from an optical record carrier,

said optical recording apparatus performing tracking control by generating a tracking error signal based on detection signals of reflected light of a main light beam and a first and a second sub light beams,

the main light beam being focused into a spot focused on a track of an optical record carrier, the first and a second sub light beams being focused into spots that are offset in opposite directions in a perpendicular direction relative to the track of the optical record carrier,

the optical recording apparatus comprising:

means for obtaining a first difference signal from detection signals of a reflection of the main light beam during a bias or erase phase of the main light beam,

means for obtaining a second difference signal from detection signals of a reflection of the first and second light beam, and

means for subtracting the second difference signal from the first difference signal so as to obtain a tracking error signal, said second difference signal being adjusted by a gain factor (g) so as to compensate at least partly for a difference in intensity between the reflected light of the first and second sub light beams during information writing.

The invention is particularly but not exclusively advantageous for obtaining an improved optical recording apparatus. In particular, the apparatus according to the present invention provides a more precise and thus more stabile optical recording apparatus.

In the second aspect of the invention, the invention relates to a situation, wherein the first difference signal is obtained when the main light beam is at a bias or erase level, thus the main light beam is not recording, but when the main light beam is at a recording power level the stored values of the first difference signal are retrieved and used for radial tracking. Thus, a sample-and-hold procedure is performed by application of an appropriate sample circuit.

The second tracking error signal may be adjusted by the gain factor (g) so as to at least partly eliminate a radial offset of the main light beam during information writing. For recording information a radial offset may be defined as the difference between the center of the written marks and the center of the so-called pregroove that guides where the written marks ideally are to be written. Thus, the precision of the apparatus is enhanced.

The gain factor (g) may be substantially equal to a correction factor (G) of the track of the optical record carrier divided by the sum of the intensity ratios (r_{A}, r_{B}) of the first and the second sub light beams relative to the main light beam as the analysis to be found below demonstrates that this value of the gain factor is beneficial. The correction factor (G) is known for the standard expression for the three spot push-pull radial error tracking method for the reading case, thus, the present invention is readily integrated with existing optical recording technologies resulting in improvements.

In particular, the gain factor (g) may be substantially equal to ⅔ times a correction factor (G) of the track of the optical record carrier for DVD recording media. Alternatively, the gain factor (g) may be substantially equal to 1/1.7 times a correction factor (G) of the track of the optical record carrier for CD recording media.

In a third aspect, the invention relates to a method for operating an optical recording apparatus capable of recording information on an optical record carrier, the method comprising the following steps:

performing tracking control by generating a tracking error signal based on detection signals of reflected light of a main light beam and a first and a second sub light beams,

focusing the main light beam into a spot focused on a track of an optical record carrier, the first and a second sub light beams being focused into spots that are offset in opposite directions in a perpendicular direction relative to the track of the optical record carrier,

obtaining a first difference signal from detection signals of a reflection of the main light beam, said detection signals being averaged using an appropriate time constant,

obtaining a second difference signal from detection signals of a reflection of the first and second light beam, and

subtracting the second difference signal from the first difference signal so as to obtain a tracking error signal, said second difference signal being adjusted by a gain factor (g) so as to compensate at least partly for a difference in intensity between the reflected light of the first and the second sub light beams during information writing.

In a fourth aspect, the invention relates to a computer program product being adapted to enable a computer system comprising at least one computer having data storage means associated therewith to control an optical recording apparatus according to the third aspect of the invention.

This aspect of the invention is particularly, but not exclusively, advantageous in that the present invention may be implemented by a computer program product enabling a computer system to perform the operations of the second aspect of the invention. Thus, it is contemplated that some known optical recording apparatus may be changed to operate according to the present invention by installing a computer program product on a computer system controlling the said optical recording apparatus. Such a computer program product may be provided on any kind of computer readable medium, e.g. magnetically or optically based medium, or through a computer based network, e.g. the Internet.

The first, second, third and fourth aspects of the present invention may each be combined with any of the other aspects. These and other aspects of the invention will be apparent from and elucidated with reference to the embodiments described hereinafter.

The present invention will now be explained with reference to the accompanying Figures, where

FIG. 1 is a schematic illustration of the 3-spot PP radial tracking method at recording,

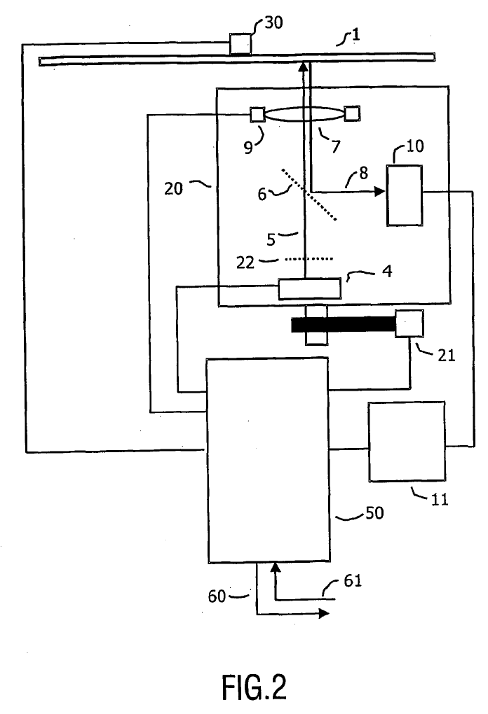

FIG. 2 is a schematic overview of the optical recording apparatus according to the present invention, and

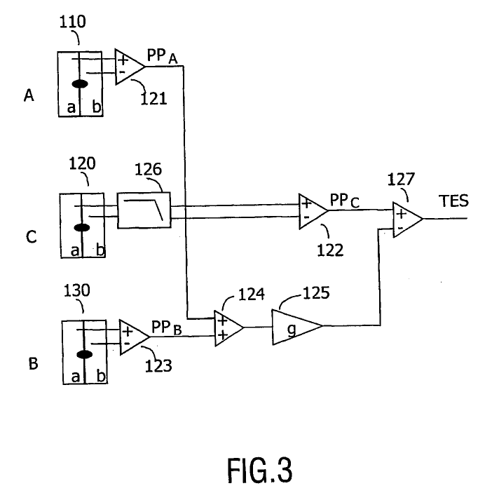

FIG. 3 is a schematic overview of the photodetection system and the circuitry means for providing a tracking error signal (TES).

FIG. 1 is a schematic illustration of the 3-spot PP radial tracking method at recording.

In FIG. 1, the main light beam is marked C and the two auxiliary light beams are marked A and B, respectively. The track n−1 is already recorded; the track n is in the process of being recording by the main light beam C, while the track n+1 is not yet recorded. The region between the tracks is often called land regions and the purpose of the radial tracking is to keep the main light beam C on the track n, thus, avoiding so-called radial beam-landing.

FIG. 2 shows an optical recording apparatus and an optical recording medium 1 according to the invention. The medium 1 is fixed and rotated by holding means 30.

The medium 1 comprises a material suitable for recording information by means of a radiation beam 5. The recording material may be of, for example, the magneto-optical type, the phase-change type, the dye type, metal alloys like Cu/Si or any other suitable material. Information may be recorded in the form of optically detectable regions, also called marks for rewriteable media and pits for write-once media, on the medium 1.

The apparatus comprises an optical head 20, the optical head 20 being displaceable by actuation means 21, e.g. an electric stepping motor. The optical head 20 comprises a photo detection system 10, a radiation source 4, a beam splitter 6, an objective lens 7, and lens displacement means 9. The optical head 20 also comprises beam splitting means 22, such as a grating or a holographic pattern that is capable of splitting the radiation beam 5 into at least three components for use in the three spot differential push-pull radial tracking control method. For reason of the clarity the radiation beam 5 is shown as a single beam after passing through the beam splitting means 22. Similarly, the radiation 8 reflected also comprises more than one component, e.g. the three spots A, B, C, and diffractions thereof, but only one beam 8 is shown in FIG. 2 for clarity.

The function of the photo detection system 10 is to convert radiation 8 reflected from the medium 1 into electrical signals. Thus, the photo detection system 10 comprises several photo detectors, e.g. photodiodes, charged-coupled devices (CCD), etc., capable of generating one or more electric output signals that are transmitted to a pre-processor 11. The photo detectors are arranged spatially to one another, and with a sufficient time resolution so as to enable detection of focus and radial tracking errors in the pre-processor 11. Thus, the pre-processor 11 transmits focus and radial tracking error signals to the processor 50. The photo detection system 10 can also transmit a read signal or RF signal representing the information being read from the medium 1 to the processor 50 through the pre-processor 11.

The radiation source 4 for emitting a radiation beam 5 can for example be a semiconductor laser with a variable power, possibly also with variable wavelength of radiation. Alternatively, the radiation source 4 may comprise more than one laser. In particular, the radiation source 4 may comprise three lasers, one laser for the main light beam C and two lasers for the sub light beams A and B if e.g. the optical head 20 does not comprises beam splitting means 22.

The optical head 20 is optically arranged so that the radiation beam 5 is directed to the optical medium 1 via a beam splitter 6, and an objective lens 7. Radiation 8 reflected from the medium 1 is collected by the objective lens 7 and, after passing through the beam splitter 6, falls on a photo detection system 10 which converts the incident radiation 8 to electric output signals as described above.

The processor 50 receives and analyses output signals from the pre-processor 11. The processor 50 can also output control signals to the actuation means 21, the radiation source 4, the lens displacement means 9, the pre-processor 11, and the holding means 30, as illustrated in FIG. 1. Similarly, the processor 50 can receive data, e.g. information to be written, indicated at 61, and the processor 50 may output data from the reading process as indicated at 60.

FIG. 3 illustrates how the photo detection system 10 comprises three photodetectors 110, 120, and 130 for detecting of the reflected light of the three spots A, B and C comprised in the reflected radiation 8. For simplicity, only a single spot is shown on the photodetectors 110, 120, and 130, but typically the first order diffraction lines (m=±1) are present as well. The photodetectors 110, 120, and 130 are further subdivided into two independent photodetectors marked a and b, respectively. By relative weighting between the half-portions marked a and b three push-pull signal PP_{A}, PP_{B}, PP_{C} are obtained for each photodetector 110, 120, and 130 by the subtraction circuits 121, 122, and 123 that are situated in the pre-processor 11. Thus, the push-pull signals PP_{A}, PP_{B}, PP_{C} are calculated within the pre-processor 11. As shown in FIG. 3, the PP_{B} is added to PP_{A} by the addition circuit 124. Subsequently, the sum of PP_{B} and PP_{A} is adjusted by the term g in the multiplication circuit 125. The two components of the push-pull signal PP_{C} from the central main beam C is initially low-pass filtered in the low pass filtering circuit 126 in order to obtain a stable signal as the reflected light of the main beam C during recording of pits or marks may vary substantially due to the nature of the recording process, e.g. phase changes or pit burning often results in a irregular reflection of the light. The components of the push-pull signal PP_{C} may be averaged by other methods readily available to the skilled person. Finally, the adjusted and summed sub beam push pull signal is subtracted from the filtered main beam push pull signal by the subtraction circuit 127 and a tracking error signal (TES), or a radial error (RE), is obtained and transmitted to the processor 50. The adjustment term g is to be varied as will be explained in further details below.

The value of the adjustment term g is found from the following analysis. Initially, it is worth remembering that in a reproducing situation the radial error (RE) or the tracking error signal (TES) is given by:

RE=PP_{c}−G/2(PP_{A}+PP_{B}), (1)

where G is a correction factor to compensate for the signal amplitude ratio between the satellite beams A and B relative to the main light beam C during retrieval of information. As it will be demonstrated below, the standard correction factor G needs to be adjusted during recording in order to avoid an radial offset when recording.

We first derive a general expression for the radial error (RE) considering the change in the local optical environment during recording. At least for DVD±R/RW and BD-R/RE media radial beamlanding will affect only the DC-content and not the PP-modulation of the left- and right halve detector signals a and b in FIG. 3.

For practical values of the beamlanding, the vertical intersection line of the photodectors 110, 120, and 130 will not cross the first-order diffraction orders, so that the PP-modulation in the photodetector portions a and b is not affected. Only the DC-content will vary. Furthermore we will assume that the PP-modulation in a and b of the photodetectors 110, 120 and 130 have an opposite phase. This is not necessarily the case for an actual media, but for the calculations it makes no difference because only the value of the general push-pull signal PP=Iₐ−I_{b}=L−R is relevant. For a given value of the PP-modulation, a certain value of the beamlanding will result in a certain offset in [nm], independent of the phase difference between a and b. We then have the following expressions for the left- and right detector halve signals, denoted here with L and R:

$${\overline{L}}_{A} = {R}_{A} [ 1 + k - m sin ( \frac{2 π x}{{T}_{p}} ) ] {\overline{R}}_{A} = {R}_{A} [ 1 - k + m sin ( \frac{2 π x}{{T}_{p}} ) ] \\ {\overline{L}}_{B} = {R}_{B} [ 1 + k - m sin ( \frac{2 π x}{{T}_{p}} ) ] {\overline{R}}_{B} = {R}_{B} [ 1 - k + m sin ( \frac{2 π x}{{T}_{p}} ) ] \\ {\overline{L}}_{C} = {GR}_{C} [ 1 + k + m sin ( \frac{2 π x}{{T}_{p}} ) ] {\overline{R}}_{C} = {GR}_{C} [ 1 - k - m sin ( \frac{2 π x}{{T}_{p}} ) ] , \qquad ( 2 )$$

where k is the DC-shift due to beamlanding, m the PP-amplitude depth relative to an average central aperture (CA), G is the correction factor during reproduction of information, x the radial spot position and Tₚ the track pitch of the media. Here we assume that the PP modulation depth m for a written area is the same as for a blank area. However, the expressions are easily adapted if they are different.

For the radial error signal RE we find:

$$RE ≡ {PP}_{C} - \frac{G}{2} ( {PP}_{A} + {PP}_{B} ) = 2 G [ ( {R}_{C} - \frac{{R}_{A} + {R}_{B}}{2} ) k + ( {R}_{C} + \frac{{R}_{A} + {R}_{B}}{2} ) m sin ( \frac{2 π x}{{T}_{p}} ) ] . \qquad ( 3 )$$

The offset Xₒ in this error signal is given by:

$$\begin{matrix}{X}_{o} = \frac{{T}_{p}}{2 π} arcsin \vert \frac{2 {R}_{c} - {R}_{A} - {R}_{B}}{2 {R}_{c} + {R}_{A} + {R}_{B}} \cdot \frac{k}{m} \vert \\ = \frac{{T}_{p}}{2 π} arcsin \vert \frac{2 - {r}_{A} - {r}_{B}}{2 + {r}_{A} + {r}_{B}} \cdot \frac{k}{m} \vert ,\end{matrix} \qquad ( 4 )$$

where r_{A}=R_{A}/R_{C} and r_{B}=R_{B}/R_{C} are the respective satellite intensity reflections relative to the central reflection intensity. We conclude that if there's no beamlanding (k=0) the offset in RE is always zero, independent of r_{A} and r_{B}, and that if there's a non-zero beamlanding (k≠0) the offset in RE is zero if r_{A}+r_{B}=2.

Estimates of the magnitude of the offset Xₒ from for the embodiment of FIG. 3, where the reflection from the main light beam C is averaged during recording, are around 26 nm for DVD+R media. For the estimate the following values have been used r_{A}=2, r_{B}=1, m=0.25 and k=0.23. This value of Xₒ may seem insignificant but for lower m-values and/or for higher k-values the offset may reach an unacceptable level.

Upon inspection of equation (2), (3) and (4) it can be shown that the offset is also zero if the G/2 value of equation (1) is replaced by:

G/2→g=G/(r_{A}+r_{B}). (5)

Notice that for the reading situation g equals G/2, which is the well-known correction factor for the symmetric situation during reading of information. For the embodiment of FIG. 3, the g value is G/3 for the DVD-R situation using the reflection ratios given above.

According to another embodiment of the invention, the averaging performed by the circuitry 126 is replaced by a sample-and-hold circuit (not shown). Thus, instead of a low pass filtering the reflection from the main light beam C during recording, the reflections from the main light beam C in between recording of marks or pits, i.e. when the laser is at an erase or bias level in the pre-groove of a track, are stored and used for radial tracking control during recording of pits or marks. This is known as the so-called sampling method. For this method r_{A}=1 and r_{B}=0.5 may be used for the DVD-R case.

It should be emphasized that once the principles of the present invention is realized, in particular equation (5), it is readily within the capabilities of the skilled person to extent the teaching of the invention for any situation where asymmetric reflection of the satellite beams A and B is present.

Although the present invention has been described in connection with the specified embodiments, it is not intended to be limited to the specific form set forth herein. Rather, the scope of the present invention is limited only by the accompanying claims. In the claims, the term comprising does not exclude the presence of other elements or steps. Additionally, although individual features may be included in different claims, these may possibly be advantageously combined, and the inclusion in different claims does not imply that a combination of features is not feasible and/or advantageous. In addition, singular references do not exclude a plurality. Thus, references to “a”, “an”, “first”, “second” etc. do not preclude a plurality. Furthermore, reference signs in the claims shall not be construed as limiting the scope.

The invention claimed is:

1. An optical recording apparatus capable of recording information on an optical record carrier,
said optical recording apparatus performing tracking control by generating a tracking error signal based on detection signals of reflected light of a main light beam (C) and a first and a second sub light beams (A, B),
the main light beam (C) being focused into a spot focused on a track of an optical record carrier, the first and a second sub light beams (A, B) being focused into spots that are offset in opposite directions in a perpendicular direction relative to the track, of the optical record carrier,
the optical recording apparatus comprising:
means (122) for obtaining a first difference signal from detection signals of a reflection of the main light beam (C), said detection signals being averaged using an appropriate time constant,
means (121, 123, 124) for obtaining a second difference signal from detection signals of a reflection of the first and second sub light beam (A, B), and
means (127) for subtracting the second difference signal from the first difference signal so as to obtain a tracking error signal, said second difference signal being adjusted by a gain factor (g) so as to compensate at least partly for a difference in intensity between the reflected light of the first and the second sub light beams (A, B) during information writing.

2. An optical recording apparatus according to claim 1, wherein the second tracking error signal is adjusted by the gain factor (g) so as to at least partly eliminate a radial offset of the main light beam (C) during information writing.

3. An optical recording apparatus according to claim 2, wherein the gain factor (g) is substantially equal to a correction factor (G) of the track of the optical record carrier divided by the sum of the intensity ratios (r_{A}, r_{B}) of the first and the second sub light beams (A, B) relative to the main light beam (C).

4. An optical recording apparatus according to claim 2, wherein the gain factor (g) is substantially equal to ⅓ times a correction factor (G) of the track of the optical record carrier.

5. An optical recording apparatus according to claim 2, wherein the gain factor (g) is substantially equal to 1/2.7 times a correction factor (G) of the track of the optical record carrier.

6. An optical recording apparatus according to claim 1, wherein the value of the gain factor (g) is determined by calibration, either during the manufacturing of the optical recording apparatus or as part of a calibration procedure before recording information on one or more optical record carriers.

7. An optical recording apparatus according to claim 1, wherein information on the gain factor (g) is read from an area on the optical record carrier, said area containing information about a recording process whereby information can be recorded on the optical record carrier.

8. An optical recording apparatus capable of recording information on an optical record carrier, and capable of reproducing information from an optical record carrier,
said optical recording apparatus performing tracking control by generating a tracking error signal based on detection signals of reflected light of a main light beam (C) and a first and a second sub light beams (A, B),
the main light beam (C) being focused into a spot focused on a track of an optical record carrier, the first and a second sub light beams (A, B) being focused into spots that are offset in opposite directions in a perpendicular direction relative to the track of the optical record carrier,
the optical recording apparatus comprising:
means (122) for obtaining a first difference signal from detection signals of a reflection of the main light beam during a bias or erase phase of the main light beam (C),
means (121, 123, 124) for obtaining a second difference signal from detection signals of a reflection of the first and second light beam (A, B), and
means (127) for subtracting the second difference signal from the first difference signal so as to obtain a tracking error signal, said second difference signal being adjusted by a gain factor (g) so as to compensate at least partly for a difference in intensity between the reflected light of the first and second sub light beams (A, B) during information writing.

9. An optical recording apparatus according to claim 8, wherein the second difference signal is adjusted by the gain factor (g) so as to at least partly eliminate a radial offset of the main light beam (C) during information writing.

10. An optical recording apparatus according to claim 9, wherein the gain factor (g) is substantially equal to a correction factor (G) of the track of the optical record carrier divided by the sum of the intensity ratios (r_{A}, r_{B}) of the first and the second sub light beams (A, B) relative to the main light beam.

11. An optical recording apparatus according to claim 9, wherein the gain factor (g) is substantially equal to ⅔ times a correction factor (G) of the track of the optical record carrier.

12. An optical recording apparatus according to claim 9, wherein the gain factor (g) is substantially equal to 1/1.7 times a correction factor (G) of the track of the optical record carrier.

13. A method for operating an optical recording apparatus capable of recording information on an optical record carrier, the method comprising the following steps:
performing tracking control by generating a tracking error signal based on detection signals of reflected light of a main light beam (C) and a first and a second sub light beams (A, B),
focusing the main light beam (C) into a spot focused on a track of an optical record carrier, the first and a second sub light beams (A, B) being focused into spots that are offset in opposite directions in a perpendicular direction relative to the track of the optical record carrier,
obtaining a first difference signal from detection signals of a reflection of the main light beam (C), said detection signals being averaged using an appropriate time constant,
obtaining a second difference signal from detection signals of a reflection of the first and second light beam (A, B), and
subtracting the second difference signal from the first difference signal so as to obtain a tracking error signal, said second difference signal being adjusted by a gain factor (g) so as to compensate at least partly for a difference in intensity between the reflected light of the first and the second sub light beams (A, B) during information writing.

14. A computer program product being adapted to enable a computer system comprising at least one computer having data storage means associated therewith to control an optical recording apparatus according to the method as claimed in claim 13.
